(19) United States
(12) Patent Application Publication
(10) Pub. No.: US 2025/0180242 A1
(43) Pub. Date: Jun. 5, 2025

(54) CONTROL KIT FOR BUILDING MANAGEMENT

(71) Applicant: BRAINBOX AI INC., Montréal (CA)

(72) Inventors: Ysael DESAGE, Mont Saint-Hilaire (CA); Vasken DERMARDIROS, Montreal (CA)

(21) Appl. No.: 18/843,349

(22) PCT Filed: Mar. 2, 2023
(86) PCT No.: PCT/CA2023/050267

§ 371 Date: Sep. 3, 2024

Related U.S. Application Data
(60) Provisional application No. 63/316,217, filed on Mar. 3, 2022.

(51) Int. Cl. F24F 11/63; F24F 11/52; F24F 110/10; F24F 110/20; F24F 130/10

(52) U.S. Cl. CPC F24F 11/63; F24F 11/52; F24F 2110/10; F24F 2110/20; F24F 2130/10

(57) ABSTRACT

A system and method for controlling HVAC components of a building are disclosed, the method including: receiving user objective indicators, each indicating a corresponding user objective for the HVAC components; receiving a plurality of forecasts, each predicting a dynamic state of the building or a usage parameter of one of the HVAC components; receiving a plurality of current states of the building; maintaining a plurality of control modules; and upon detecting a change in at least one of the forecasts or at least one of the user objective indicators: performing a plurality of HVAC control simulations, each simulating the performance of a corresponding subset of the control modules; selecting a subset of the control modules based on results of the simulations and the one or more user objective indicators; and deploying the selected subset of control modules to control the HVAC components.

### CROSS-REFERENCE TO RELATED APPLICATION

This application claims the benefit of and priority to U.S. provisional patent application No. 63/316,217 filed 3 Mar. 2022, the entire content of which is hereby incorporated by reference.

### FIELD

This disclosure relates generally to building management or building automation. More specifically, it relates to systems and methods for dynamic control of the HVAC control systems and components in a building.

### BACKGROUND

Building management systems (BMS) or building automation systems (BAS) are systems used in buildings to manage heating, ventilation and air conditioning (HVAC), lighting, power, security, elevators and other building systems.

HVAC constitutes around anywhere from 30% to 60% (e.g., 40%) of a commercial building's total energy and it is now becoming a priority to achieve HVAC energy reduction, but energy efficient HVAC is not simple to achieve or sustain. Even new “state of the art” commercial HVAC systems lose operational efficiency post installation due to the way they are designed, installed and maintained.

Traditionally, HVAC systems are considered as a group of independent mechanical equipment. Each pump, chiller, tower and air handling unit are designed to be turned on, run at a fixed speed and turned off. This way of thinking leads to a logic of equipment components that are designed to operate efficiently in isolation, and a BMS that controls the equipment by turning it on and off automatically. Operating data that typically resides in the typical BMS is not easily accessible by building operators. If operating data is available, it may be in the form of unformatted streams of data points, a format that is incompatible with performance measurement or problem diagnosis.

Management of HVAC by BMS or BAS generally involves the use of thermostats or other sensors provided at various locations in the building, with each thermostat acting as a sensor measuring the temperature at its specific location. Typically, thermostats include a target temperature range, (i.e., a target temperature, accompanied by a value that is added to or subtracted from the target temperature and thus defining what is called the acceptable temperature band). This temperature range can be changed by room occupants or building operators. When the measured temperature in the room of the thermostat is out of the target temperature range, the thermostat sends an instruction to the HVAC equipment to start heating or cooling the room. This responsive management of room temperature may be inefficient and not cost effective. Improved efficiency and cost effectiveness can be obtained if occupancy of the room or other environmental variables which affect the thermal targets within the building are considered in the control of the HVAC system. In addition to improving efficiency and reducing costs, HVAC control that would be predictive as opposed to responsive would improve comfort and provide additional energy savings.

In order to link temperature control with room occupancy, many existing BMS or BAS require replacing existing thermostats with thermostats with occupancy or vacancy sensors or adding occupancy or vacancy sensors to specific rooms and linking these additional sensors to HVAC control to use this data. In large buildings, there can be hundreds of thermostats. The cost and effort of replacing hundreds of simple thermostats with thermostats with occupancy sensors can be significant and is a major hurdle for the adoption of this technology in large buildings.

HVAC control by many existing BMS or BAS tends to be based on a fixed control sequence designed for a typical day of the actual season and not on the actual conditions. Such HVAC control does not take into account wide fluctuations in temperature that can occur on a day to day basis within a particular season. Existing BMS and BAS generally do not keep a detailed history of each and every data point; typically, only trend logs are kept in a database for a limited time in order to avoid needing infrastructure necessary to store extremely large data sets. This however prevents any behavior-learning analysis that would be needed to understand how the thermal energy moves within a specific building and what can be done to optimize this movement. Only a large quantity of points with months of detailed value (e.g., raw data in a large history dataset) could provide enough details to analysis these thermal energy behaviors that are unique to a building.

There have been attempts to improve BMS or BAS by connecting the system to an additional device to better manage the use of energy in HVAC systems. For example, there are light fixtures that detect room occupancy, or intelligent thermostats that detect room occupancy and other variables and can change their target temperature depending on these variables or depending on forecasted needs. Some of these thermostats can also predict that a future target temperature is about to be reached and instruct the HVAC system to change its operation based on this forecast. These systems are however costly and require physical modifications of the building.

### SUMMARY

In accordance with an aspect, there is provided a computer-implemented system for controlling HVAC components of a building, the system may include: a processor; a memory storage device storing a set of instructions, the set of instructions when executed by the processor, cause the processor to: receive one or more user objective indicators, each indicating a corresponding user objective for the HVAC components; receive a plurality of forecasts, each predicting a dynamic state of the building or a usage parameter of one of the HVAC components; receive a plurality of current states of the building; maintain a plurality of control modules, each for controlling at least one setting of the HVAC components; and upon detecting a change in at least one of the forecasts or at least one of the user objective indicators: perform a plurality of HVAC control simulations, each simulating the performance of a corresponding subset of the control modules based on the plurality of forecasts and the plurality of current states of the building; select a subset of the control modules from among the simulated subsets of the control modules based on results of the simulations and the one or more user objective indicators; and deploy the selected subset of control modules to control the HVAC components.

In some embodiments, the plurality of forecasts may include at least one of: a predicted temperature value, a predicted water usage amount, a predicted electricity usage amount, a predicted gas usage amount, a predicted weather, and a predicted humidity level.

In some embodiments, at least one of the plurality of control modules may include a machine learning model.

In some embodiments, the plurality of current states of the building may include at least one of: a number of zones, a temperature measurement, a set point, sensor data, actuator data, occupancy schedule, and occupancy data.

In some embodiments, the plurality of current states of the building is received from a Building Management System (BMS).

In some embodiments, the one or more user objective indicators may include at least one of: an operational cost, a power, a water usage amount, an electricity usage amount, a gas usage amount, a humidity level, an emission target, equipment runtime, an equipment cycling rate, a temperature target, and an air quality target.

In some embodiments, deploying the selected subset of control modules to control the HVAC components may include: executing the selected subset of control modules; and generating one or more operating values for the HVAC components based on the execution of the selected subset of control modules; and transmitting the one or more operating values to the HVAC components.

In some embodiments, the system further has a display device for displaying the one or more operating values for the HVAC components.

In some embodiments, the user objective indicators are weighted.

In accordance with another aspect, there is provided a computer-implemented method for controlling HVAC components of a building, the method may include: receiving one or more user objective indicators, each indicating a corresponding user objective for the HVAC components; receiving a plurality of forecasts, each predicting a dynamic state of the building or a usage parameter of one of the HVAC components; receiving a plurality of current states of the building; maintaining a plurality of control modules, each for controlling at least one setting of the HVAC components; and upon detecting a change in at least one of the forecasts or at least one of the user objective indicators: performing a plurality of HVAC control simulations, each simulating the performance of a corresponding subset of the control modules based on the plurality of forecasts and the plurality of current states of the building; selecting a subset of the control modules from among the simulated subsets of the control modules based on results of the simulations and the one or more user objective indicators; and deploying the selected subset of control modules to control the HVAC components.

In some embodiments, the plurality of forecasts may include at least one of: a predicted temperature value, a predicted water usage amount, a predicted electricity usage amount, a predicted gas usage amount, a predicted weather, and a predicted humidity level.

In some embodiments, at least one of the plurality of control modules may include a machine learning model.

In some embodiments, the plurality of current states of the building may include at least one of: a number of zones, a temperature measurement, a set point, sensor data, actuator data, occupancy schedule, and occupancy data.

In some embodiments, the plurality of current states of the building is received from a Building Management System (BMS).

In some embodiments, the one or more user objective indicators may include at least one of: an operational cost, a power, a water usage amount, an electricity usage amount, a gas usage amount, a humidity level, an emission target, equipment runtime, an equipment cycling rate, a temperature target, and an air quality target.

In some embodiments, the user objective indicators are weighted.

In some embodiments, deploying the selected subset of control modules to control the HVAC components may include: executing the selected subset of control modules; and generating one or more operating values for the HVAC components based on the execution of the selected subset of control modules; and transmitting the one or more operating values to the HVAC components.

In accordance with yet another aspect, there is provided a computer-implemented system for controlling HVAC components of a building, the system may include: a building management system (BMS) configured to manage and maintain a plurality of current states of the building; and a computing device connected to the BMS, having a processor and a memory storage, the memory storage storing a set of instructions, when executed by the processor, causing the processor to: receive one or more user objective indicators, each indicating a corresponding user objective for the HVAC components; receive a plurality of forecasts, each predicting a dynamic state of the building or a usage parameter of one of the HVAC components; receive the plurality of current states of the building from the BMS; maintain a plurality of control modules, each for controlling at least one setting of the HVAC components; and upon detecting a change in at least one of the forecasts or at least one of the user objective indicators: perform a plurality of HVAC control simulations, each simulating the performance of a corresponding subset of the control modules based on the plurality of forecasts and the plurality of current states of the building; select a subset of the control modules from among the simulated subsets of the control modules based on results of the simulations and the one or more user objective indicators; and deploy the selected subset of control modules to control the HVAC components.

In some embodiments, the plurality of forecasts may include at least one of: a predicted temperature value, a predicted water usage amount, a predicted electricity usage amount, a predicted gas usage amount, a predicted weather, and a predicted humidity level.

In some embodiments, at least one of the plurality of control modules may include a machine learning model.

In some embodiments, the plurality of current states of the building may include at least one of: a number of zones, a temperature measurement, a set point, sensor data, actuator data, occupancy schedule, and occupancy data.

In some embodiments, the one or more user objective indicators may include at least one of: an operational cost, a power, a water usage amount, an electricity usage amount, a gas usage amount, a humidity level, an emission target, equipment runtime, an equipment cycling rate, a temperature target, and an air quality target.

In some embodiments, the user objective indicators are weighted.

In accordance with yet another aspect, there is provided a non-transitory computer-readable medium having stored thereon machine interpretable instructions which, when executed by a processor, cause the processor to perform the computer-implemented method claimed in any one of the above claims.

Many further features and combinations thereof concerning embodiments described herein will appear to those skilled in the art following a reading of the instant disclosure.

### BRIEF DESCRIPTION OF THE DRAWINGS

In the drawings, embodiments are illustrated by way of example. It is to be expressly understood that the description and drawings are only for the purpose of illustration and as an aid to understanding, and are not intended as a definition of the limits of the invention.

Embodiments will now be described, by way of example only, with reference to the attached figures, wherein:

FIG. 1A is a schematic diagram illustrating an example system having a controller device for control of the HVAC components of a building, according to one embodiment.

FIG. 1B is a schematic diagram illustrating another example system having a controller device for control of the HVAC components of a building, according to one embodiment.

FIG. 2 is a schematic diagram illustrating various parameters in a building that can be controlled by a controller device, according to one embodiment.

FIG. 3 is a schematic diagram illustrating an exemplary architecture of a system including a controller device for control of the HVAC components of a building, according to one embodiment.

FIG. 4 is another schematic diagram illustrating an exemplary architecture of a system including a controller device for control of the HVAC components of a building, according to one embodiment.

FIG. 5 is a schematic diagram of an example architecture of a neural network maintained by a machine learning model of the controller device, in accordance with an embodiment.

FIG. 6 is an example set of inputs and outputs for one or more deep learning models maintained by a controller device for dynamic management of the HVAC components of a building, according to one embodiment.

FIG. 7 is another example set of inputs and outputs for one or more deep learning models maintained by a controller device for dynamic management of the HVAC components of a building, according to one embodiment.

FIG. 8 is an example set of inputs and outputs for one or more control modules maintained by a controller device for dynamic management of the HVAC components of a building, according to one embodiment.

FIG. 9 is yet another example set of inputs and outputs for one or more deep learning modules maintained by a controller device for dynamic management of the HVAC components of a building, according to one embodiment.

FIG. 10 is an example process performed by a controller device for dynamic management of the HVAC components of a building, according to one embodiment.

FIG. 11 is a schematic diagram of computing device which may be used to implement a controller device.

FIG. 12 illustrates an example user interface for dynamic management of the HVAC components of a building, according to one embodiment.

FIG. 13 illustrates an example graph showing energy savings after deployment of an example system for dynamic management of the HVAC components of a building, according to one embodiment.

FIG. 14 illustrates two tables showing energy savings after deployment of an example system for dynamic management of the HVAC components of a building, according to one embodiment.

These drawings depict exemplary embodiments for illustrative purposes, and variations, alternative configurations, alternative components and modifications may be made to these exemplary embodiments.

### DETAILED DESCRIPTION

Efficient management and operation of the Heating, Ventilating and Air Conditioning (HVAC) system(s) in a building or network of building can reduce energy consumption leading to a reduction in building operating costs. Predictive or more finely tuned responsive control of the HVAC systems can not only improve efficiency but also improve environmental conditions, comfort and reduce management time.

The present disclosure provides systems and methods for dynamic control and management of the operation of the HVAC components in a HVAC system, which may execute a combination of different control modules based on historical and current data, as well as meteorological forecasts or other factors including room occupancy that impact in-door environmental conditions.

In some embodiments, an example system disclosed herein may include a control module configured to extract and monitor all data items, i.e. “points” and considers the thermodynamic properties of both the building as a whole and zones therein to predict the value of all data items, i.e. “points” and control each component of the HVAC system to optimize HVAC performance. Components and operating parameters of the HVAC system controlled by the example system may include set points, fan speed, valve openings, damper position, temperature of the cold water, temperature of the hot water, pipe pressure, differential pressure, pump speed, evaporator rate, and compressor pressure, amongst others.

In some embodiments, an example system disclosed herein may be configured to send instructions to the BMS/BAS to adjust operating parameters of one or more or all HVAC components and operating parameters or to send instructions directly to one or more specific HVAC equipment.

In some embodiments, an example system disclosed herein may provide and enable predictive HVAC control. The example system may maintain or update a control module which can utilize advanced data processing and/or artificial intelligence including traditional linear, non-linear regression models, supervised learning, unsupervised learning, and deep learning techniques to provide predictive HVAC control systems and modules that are capable of learning. In some embodiments the example system may integrate and interconnect devices including sensors, and HVAC components, within existing building infrastructure using wired or wireless networks. Some of the features described herein may utilize big data systems, machine learning and artificial intelligence, cloud computing technologies, and cloud services, for example.

Predictive control of the HVAC system can include control of one or more HVAC systems based on forecasted future outdoor environmental conditions and historic internal features or behaviors, which may include but not limited to: temperatures, wind speed and direction, cloud cover percent, eclipses, outdoor humidity, time of day, date, thermodynamic patterns derived from historic dataset and predicted occupancy amongst other factors.

In some embodiments, a control module may use artificial intelligence (AI) and machine learning, based on historical data, to predict impact of current or anticipated environmental conditions on HVAC system operation and to control HVAC system operation based on the predicted impact. For example, a control module may use AI and machine learning to predict impact of El Nino climate events.

In some embodiments, an example system disclosed herein may be configured to detect anomalous or abnormal behavior including HVAC system operation needs outside of predicted parameters. In some embodiments, the detection of any change in the inputs, or the detection of any anomalous or abnormal behavior, can trigger a control module in the system to undergo a period of retraining. In some embodiments, the detection of anomalous or abnormal behavior includes detection of HVAC operations outside of normal operating patterns. Optionally, in such embodiments, the system may provide an alert that anomalous or abnormal behavior has been detected. For example, predicted future outdoor temperature or environmental conditions can be based on historical data, meteorological forecasts or climate pattern cycle including regular cycles such as diurnal or seasonal cycles and quasi periodic events such as El Nino.

In some embodiments, an example system disclosed herein may be configured to take into consideration changes in human behavior associated with the weather fluctuation and the seasonal changes, for example, in-door temperature set points may be set higher in the summer to account for lighter weight clothing.

In some embodiments, an example system disclosed herein may receive forecasts or other information from third party providers including government weather stations. Meteorological forecasts include short range, medium range and long range meteorological forecasts. The weather conditions and forecasts may be updated at regular intervals. In some embodiments, weather information and tracking are updated at fixed intervals, for example, every 1, 5, 10, 15, 20, 30 or 60 minutes. Optionally, in some embodiments, the system may be configured to use historical data to predict impact of specific weather conditions on HVAC needs for specific parts of the building as zones or rooms with exterior walls or windows may be more impacted by outside conditions than interior zones or rooms.

In embodiments, when an example system receives meteorological forecasts, one or more HVAC component operations may be adjusted based on these forecasts. For example, in embodiments where the HVAC system comprises multiple HVAC units, individual units may be turned on or off or adjusted based on anticipated need, optionally allowing for the selection of heating or cooling units based on anticipated conditions and allowing for the operation of multiple units at part-load, if such operation is more efficient than operation of a single unit at full load. In some embodiments, where multiple chillers serve the building the systems and methods may provide for chiller staging. Optionally, chiller staging considers equipment configuration and type, refrigerating capacity, chilled water flow rates, power consumption by water condensers and water tower fans.

In some embodiments, buildings may be pre-cooled or heated in anticipation of changes in temperature thereby optionally allowing for off-peak electricity consumption.

In some embodiments, an example system may be configured to pre-emptively cool or heat specific areas of a building based on sun position or solar path. The system may further be configured to account for shadows, cloud cover or reflected sunlight from surrounding structures or buildings. Optionally, in some embodiments, the system may be configured to adjust building air flow patterns in response to sun position or solar path. The system may further be configured such that adjustment of the operation of the HVAC system based on sun position or solar path does not occur when there is cloud cover or cloud cover above a specific level.

In some embodiments, an example system may be configured to control dampers or shutters to affect airflow to either increase or decrease heat transfer.

In some embodiments, an example system may be configured to control ventilation or air flow to redistribute heat or cool air, for example, to regulate air flow to move cooler air from basement levels to upper levels. In some embodiments, the system may be configured to regulate intake of outdoor air and optionally to use outdoor air for space cooling, for example, to flush the building with cool outdoor air at night to reduce or avoid cooling during the daytime. The system may be further configured to redistribute heat or cool air only if the redistribution is cost effective or otherwise advantageous.

In some embodiments, an example system may be configured to control HVAC components based on room occupancy including controlling heating, cooling and ventilation based on actual or predicted occupancy. Optionally, zones or rooms may be pre-emptively cooled or heated based on predicted occupancy rates. In some embodiments, usage of supply air fans, hood exhaust and make up fans is dependent on actual or predicted occupancy where usage is reduced in unoccupied rooms or zones. The system may be optionally figured to automatically switch on ventilation system or electrical components (e.g., lights) if occupants are detected in the room or zone. Optionally, in addition to occupancy the type of occupancy is considered, for example, occupants involved in strenuous activity will impact environmental conditions to a greater extended then occupants who are not active.

Room occupancy may be determined or predicted based on historical data, schedules (i.e., scheduled room occupancy), day of the week, and so on. In some cases, determining room occupancy may be based on motion sensors and PIR sensors amongst others.

In some embodiments, historic room occupancy may be determined based on fluctuations in room environmental readings from HVAC sensors including temperature, humidity, and CO₂.

In some embodiments, occupancy data may be provided by a third party, for example, based on the number of cellular or Wi-Fi connected mobile device. For example, a commercially available product Skyfii can provide intelligence regarding real time occupancy in a given physical space.

In some embodiments, historic room occupancy may be determined based on changes in energy required to maintain a set temperature.

In embodiments where room occupancy is predicted, HVAC settings can be adjusted to account for number of anticipated occupants to compensate or adjust for heat or CO₂ generated by the occupants of the space. Optionally, the system may control ventilation of a specific space on the basis of controlling for either actual or anticipated CO₂ levels. In some embodiments, outdoor ventilation rate is minimized to the rate necessary to maintain acceptable air quality, i.e., CO₂ levels. In environments with extreme weather conditions, indoor air is optionally filtered to minimize amount of outdoor ventilation required.

In some embodiments, an example system may be configured to control head pressure of water-cooled condensers to improve energy efficiency of air conditioning in part-load conditions. In such embodiments, the system may be configured to determine optimal head pressure or calculate a floating head pressure and maintain the optimal head pressure by using variable speed drive controllers or condenser water modulating head pressure valves. The system may optionally further provide for variable or floating temperature set points of heating hot water (HHW), chilled water (CHW) and condenser water (CW) whereby the temperature (or grade) of the thermal energy is dynamically adjusted (or reset) to minimize the energy consumption of the associated HVAC equipment. For example, the system may be optionally configured to provide the coolest possible water for heating; the warmest possible water for cooling and/or the coolest possible CW for cooling of refrigeration equipment.

In some embodiments, an example system may be configured to manage building energy consumption including managing electric consumption during peak demand time thereby reducing costs.

In some embodiments, an example system may be configured to manage HVAC components in response to outside air quality and/or air quality within a specific area or zone. For example, the system may be configured to control ventilation rate based on measured pollutant level including level of carbon monoxide and/or nitrous oxides in a particular zone or area such as a car park or loading dock. Optionally, the system may be further configured to direct flow of outside or indoor air through filters to improve air quality, when necessary.

Optionally, the example system may be configured to adjust air flow or air intake in response to outside air quality. For example, in some embodiments, outside air is filtered or purified if outside air quality is low such that airborne particles, likes dust, pollen and bacteria are removed. Accordingly, in some embodiments, air intakes are selected based on actual or anticipated air quality.

In some embodiments, where multiple factors are considered in predicting HVAC requirements, individual factors can be weighted. Weighting of factors may be based on historical data or anticipated impact.

In some embodiments, an example system may be configured to allow building operators to weight or prioritize one or more factors, for example, maximize energy efficiency or cost savings. In such embodiments, a user interface may be provided allowing for selection or ranking of priorities.

In some embodiments, an example system may be configured to control HVAC components to minimize energy expenditure while maintaining a minimum comfort in occupied zones and/or areas by taking into account factors that impact perceived comfort level of an occupant, including temperature and humidity. For example, set point for temperature and humidity are both adjusted to maintain comfort while reducing energy requirement.

In some embodiments, an example system may be configured for a single building or a network of buildings. In some embodiments, the two or more buildings in the network of buildings are physically connected, for example, by tunnels, enclosed walkways, bridges. In such cases, set points for temperate and humidity in a first building may affect set points for temperate and humidity in a connected, second building, and the example system may be configured to operate the HVAC components of the buildings as a whole.

In some embodiments, an example system may be configured for retrofit into existing building and be further configured to interface with existing HVAC components. In other embodiments, the system may be incorporated into new builds. In new builds, the system and methods are optionally integrated into or are a module of the BMS or BAS.

In some embodiments, an example system may be configured to interact directly with components of the HVAC system, for example in direct communication with the sensors and the actuators/controllers of the HVAC system. In alternative embodiments, the system may communicate directly with the existing master controller. Optionally, the system may be a combination of direct interact interaction with the master controller and direct communication with components of the HVAC system.

In some embodiments, an example system may generally include a controller device in communication with sensors and components of the HVAC system. The controller device may be further connected to a remote server or cloud server. In some embodiments, both the controller device and remote server or cloud server include algorithm modules configured to analyze data. Optionally, the controller device is configured to determine the micro and time sensitive parameters and the algorithm module on the remote or cloud server is configured to determine macro and mid or long-term parameters.

In some embodiments, the controller device includes an algorithm module configured to calculate both macro and micro parameters. Macro parameters can represent the big trends and include forecast and/or prediction values for the next 1 to 8 hours. In some embodiments, the prediction may have an accuracy associated with a certain time frame, such as within 15 minutes before or after the point in time for which the prediction is made. Micro parameters can include the forecast values for the next 60 minutes and may include the precise value for each command points. In some embodiments, the prediction may have an accuracy associated with a certain time frame, such as within 3 minutes before or after the point in time for which the prediction is made. In such embodiments, the controller device can use the macro predictions to define the precise values of each point command in the HVAC system. Optionally, in some embodiment, the controller device is configured to keep using the last macro report received until it reaches the end of the 8 hours.

Analysis of sensor data and/or calculation of HVAC parameter changes may be completed on the on-site controller device, on the remote server or cloud server or combination thereof. In some embodiments, the system is configured such that processing is switched to the on-site controller device if there is no link to the remote server or cloud server.

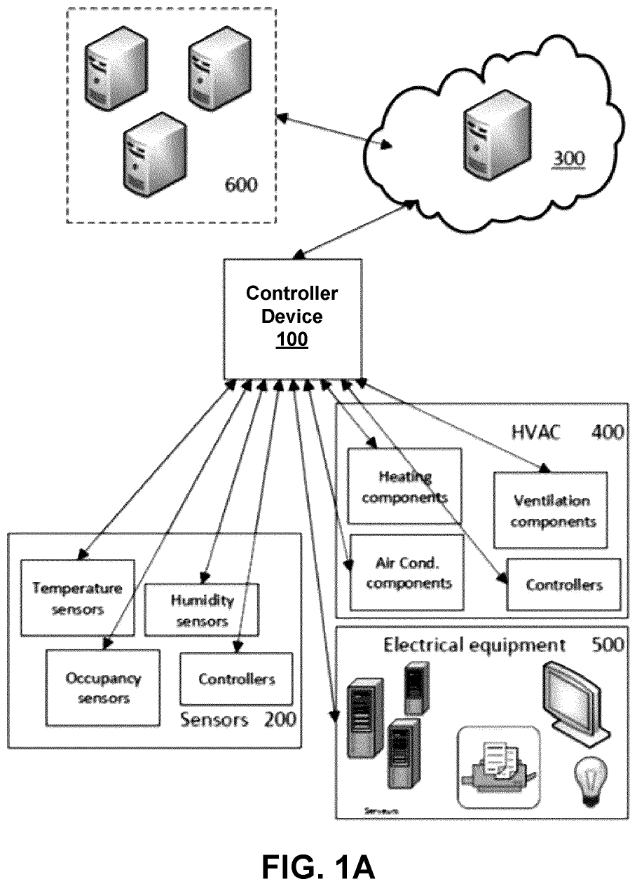

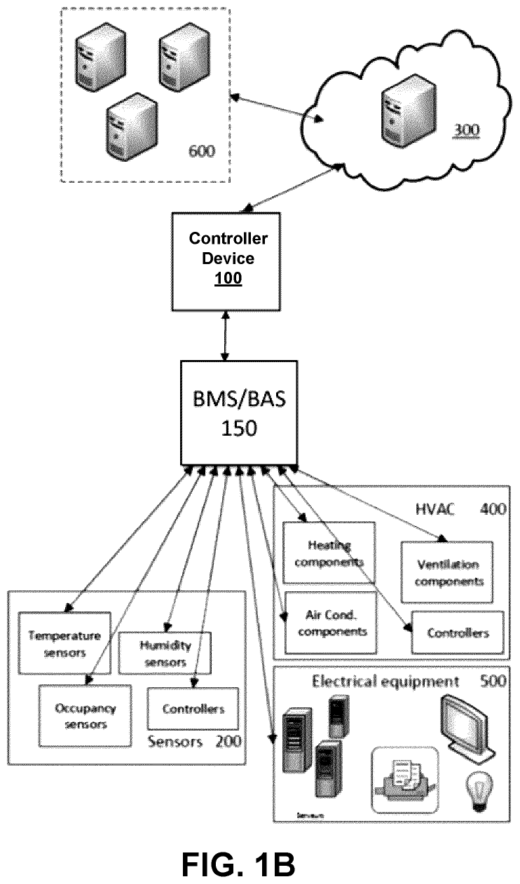

In one embodiment, referring to FIG. 1A, there is illustrated a system having a controller device 100 in communication with HVAC components 400 of the building and with a remote server 300. More specifically, there is described a system for managing HVAC components 400 of a building, the system including: a processor; a memory storage device storing a set of instructions, the set of instructions when executed by the processor, cause the processor to: receive one or more user objective indicators, each indicating a corresponding user objective for the HVAC components 400; receive a plurality of forecasts, each predicting a dynamic state of the building or a usage parameter of one of the HVAC components 400; receive a plurality of current states of the building; maintain a plurality of control modules, each for controlling at least one setting of the HVAC components 400; and upon detecting a change in at least one of the forecasts or at least one of the user objective indicators: perform a plurality of HVAC control simulations, each simulating the performance of a corresponding subset of the control modules based on the plurality of forecasts and the plurality of current states of the building; select a subset of the control modules from among the simulated subsets of the control modules based on results of the simulations and the one or more user objective indicators; and deploy the selected subset of control modules to control the HVAC components 400.

In some embodiments, the plurality of forecasts may include at least one of: a predicted temperature value, a predicted water usage amount, a predicted electricity usage amount, a predicted gas usage amount, a predicted weather, and a predicted humidity level. Some forecasts, such as the predicted temperature value, predicted electricity usage or the predicted humidity level, may be determined based in part on a weather forecast from a remote server 300 or third party servers 600.

A forecast predicting a dynamic state of the building may be obtained from one or more control modules, or from the BAS/BMS if there is one. The dynamic state may include, for example, a predicted occupancy level in one more zones of the building.

In some embodiments, the plurality of current states of the building may include at least one of: a number of zones, a temperature measurement, a set point, sensor data, actuator data, occupancy schedule, and occupancy data. In some embodiments, the plurality of current states of the building is received from a Building Management System (BMS) 150.

In some embodiments, the one or more user objective indicators may include at least one of: an operational cost, a power, a water usage amount, an electricity usage amount, a gas usage amount, a humidity level, an emission target, equipment runtime, an equipment cycling rate, a temperature target, and an air quality target.

In some embodiments, deploying the selected subset of control modules to control the HVAC components may include: executing the selected subset of control modules; and generating one or more operating values for the HVAC components based on the execution of the selected subset of control modules; and transmitting the one or more operating values to the HVAC components.

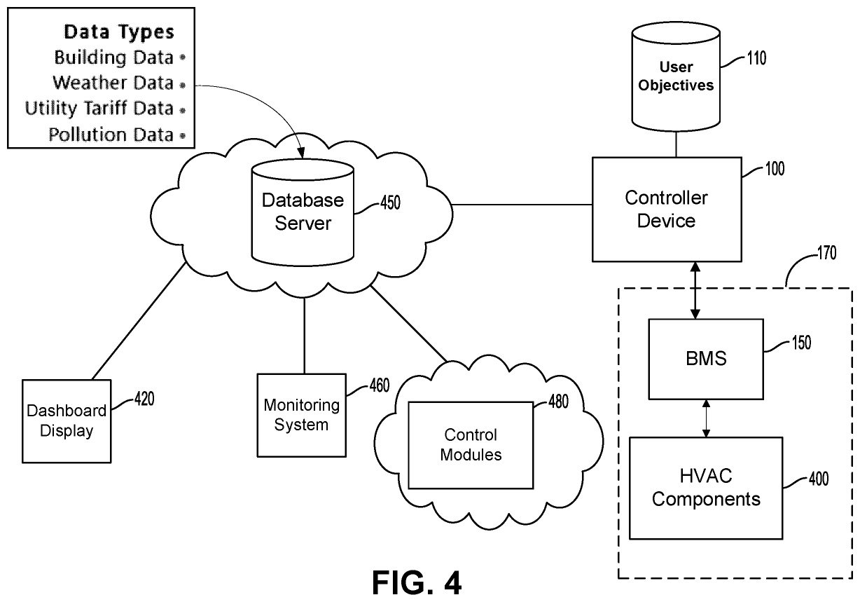

In some embodiments, the system further has a display device for displaying the one or more operating values for the HVAC components. The display device may be, for example, display device 420 shown in FIG. 4.

In an alternative embodiment, referring to FIG. 1B, an example system may include a controller device 100 in communication with the existing BMS or BAS 150 and with a remote server 300. Forecasts can be provided directly from third party servers 600 to the controller device 100 or via the remote server 300 as shown. More specifically, there is a system for managing HVAC components 400 of a building, the system comprising a controller device 100 in communication with the pre-existing BMS or BAS 150. The BMS or BAS 150 communicates with sensors 200 in the building and with the HVAC components 400 and acts as an intermediary between the controller device 100 and sensors 200 and the HVAC components 400 such that the controller device 100 provides control instructions to the BMS or BAS 150 which then communicates with the necessary HVAC components 400. Similarly, sensors 200 communicate with the BMS or BAS 150 which then transmits the data to controller device 100.

In a further example embodiment, the system comprising a controller device 100 in communication with the existing BMS or BAS 150 and one or more sensors 200 or one or more HVAC components 400.

Embodiments of the system do not require changing thermostats of the building, allowing retrofitting of the system using existing thermostats. A controller device 100 can be advantageously provided and made to be in communication with the existing BMS/BAS 150 the sensors 200, the actuators, and/or the individual controllers, and the internet, for low-cost and simple retrofitting of the existing thermostats and HVAC equipment in the building. Actuators in HVAC systems control the dampers. By utilizing a low voltage signal, the actuator places the damper at any point between fully open and fully closed.

The system, as illustrated in FIGS. 1A and 1B, can be an IoT (Internet of Things) solution to individually control HVAC components 400 of a building management system (BMS) 150 in order to optimize the efficiency of the whole system. The system can advantageously make use of existing sensors 200 (e.g., thermostats which comprise a thermometer) throughout the building, and of actuators or controllers on the various HVAC components 400 to individually control each one of them, at an individual component level. A controller device 100 is in communication both with these sensors 200, the actuators, and with the internet (i.e., a remote server 300). By converting data formats, the controller device 100 is adapted to receive information from the sensors 200 and transmit to the actuators even though the format of the data is heterogeneous.

In some embodiments, the controller device 100 may execute one or more control modules that implement one or more algorithms to predict a building's needs in terms of heating, cooling and ventilation throughout the building. These predictions may be based on data acquired from the sensors 200 (e.g., sensors to detect air temperature, velocity, humidity and pressure, human presence) and data acquired from the internet (e.g., local weather forecast, including sunlight intensity and orientation, and temperature, wind or precipitation). By running analytics on the historic dataset of the building into the program, the controller device 100 can determine how to control each of the HVAC components 400 to optimize the system (i.e., minimize cost or energy consumption). Electrical equipment 500 can also be controlled in a similar fashion by the controller device 100. This applies specially to lighting, the needs of which depend strongly on occupancy, which is measured, and which affects heating or AC needs. This can also apply to other types of equipment having similar requirements and effects, such as industrial equipment, local servers, electrical loads which depend on occupancy (e.g., ornamental equipment), electricity distribution equipment, electricity storage (i.e., battery banks and the like), alarms systems, and so on.

The control modules can be stored and executed on either or both of the controller device 100 and on remote servers 300 (e.g., the cloud) depending on the needs in terms of bandwidth and time reactivity.

Based on the analysis and determination from the controller device 100, each HVAC component 400 is instructed, through the controller device 100, to modulate its operation. The components can include, for example (without limitation): air system components (fresh air intake; duct, exhaust and supply fans, night purge, (de-humidification), cooling system components (chillers, compressors, condenser water delivery, head pressure, condensing pressure) and heating system components (boiler, steam pressure or delivery). A very large number of components can be managed and controlled by the controller device 100 in real time or near real time based on a variety of input including current states of the building, different forecasts, and different user objectives.

In some embodiments, the controller device 100 may connect to an electrical or thermal storage device, such as, for example, battery systems, electric vehicles, or fuel cell systems. The controller device 100 may further connect to a potential energy storage system such as a flywheel, compressed air tank, water storage tank, underground thermal, one or more storage mediums, phase-change materials, and so on.

In some embodiments, the controller device 100 may connect to one or more district heating provider (e.g., hot water or steam provider) or a cooling provider (e.g., cold water provider).

Today, large buildings make heavy use of Building Management Systems (BMS) thus making equipment operating conditions more visible to the operators, and also more easily controllable. This visibility focuses all the attention on the monitoring tools and is not concerned by thermodynamic equilibrium within the building. Indeed, the focus of prior art BMS is made on the optimization of individual equipment performance while at the same time discarding more than 50% of a building's thermal energy into the environment. Instead of managing the operating conditions of individual equipment, as in typical BMS, the disclosed system and controller device 100 are configured to manage the energy flow in the building by collecting real time data from sensors 200 located throughout a building and by managing the heat flow as a whole.

The system may be configured to reduce the inefficiency of the thermal energy in buildings. A controller device 100 can be used not only to collect data from sensors 200, but also to connect with (through a BMS 150 in some cases) every chiller (or any other cooling system component), boiler (or any other heating system component), pump and an entire array of the control points of a building. With this infrastructure capability, advanced algorithms or modules can be deployed by being installed on an easy-to-deploy controller device 100 to deliver dynamic states of the building base on real time environmental conditions and the internal load of the building, thus keeping all the mechanical systems optimally positioned 24/7. This can be made by connecting the controller device 100 with existing equipment (e.g., sensors 200, controllers, actuators of HVAC components 400), sometimes through the BMS 150. By putting the intelligence in the controller device 100 and not on the equipment (sensors, controllers, actuators), the existing equipment do not need to be replaced and retrofitting is made possible. The deployment of the system would thereby eliminate drifting and reduce occupant complaints, equipment alarms and periodic commissioning (physical inspections and maintenance). HVAC systems that are producing and distributing the precise quantity of thermal energy needed in real time to provide occupant comfort will attain a thermal balance performance level.

The potential energy savings unlocked by the disclosed embodiments, when retrofitted to existing HVAC equipment within a building, goes well above 30% of the HVAC energy consumption. In some situations, by combining advanced control modules to match the weather pattern with the thermal load requirement of the building in real time or near real time, it becomes possible to deliver a lower kW/ton ratio.

In some embodiments, the controller device 100 may implement relational-control algorithms to optimize all the equipment within an all-variable flow HVAC system (chillers, fans, pumps, etc.). By doing so, the controller device 100 may use the least amount of power required to maintain occupant comfort levels. Control set points are automatically calculated based on real time building load information inputs and the weather conditions prevailing outside of the building. This approach results in a global thermal load management for the building instead of an equipment-based management strategy.

The controller device 100 may implement relational-control algorithms to monitor the different parameters of the entire fleet of equipment and sensors 200 within a building to deliver continuous, automatic adjustments to the system based on the building load, regardless of facility type. In some embodiments, an example objective of these systems and methods is to generate energy usage savings (kWh/yr.), demand savings (KW), heating/cooling load (Therms), cooling tower water usage savings (gal/yr.), carbon footprint reduction (lbs./yr.) and Power Usage Effectiveness (PUE) Reduction. By doing so, these systems and methods save impressive amount of dollars, reduce the load on the grid and improve tenant comfort.

This global view of a building, as monitored via the controller device 100, can provide real time system adjustment recommendations, identify operational inefficiencies, and provide real time or near real time building re-commissioning at any time of the day. In some embodiments, this controller device 100 can manage energy demand by analyzing building occupancy, the building's thermodynamic patterns and outside weather to automatically adjust the heating and cooling of the building's different zones to the optimal levels in real time.

According to an embodiment, the system can include a remote server 300 connected to the controller device 100. The remote server 300 can be a single server, a plurality of servers wherein each one is dedicated to certain tasks, or a plurality of servers organized in a network to perform tasks in a distributed manner, e.g., the cloud.

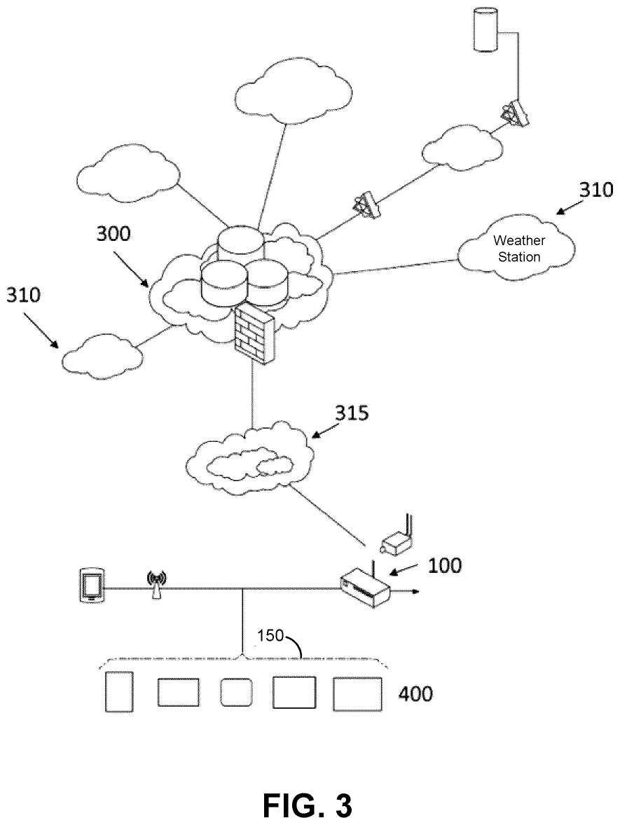

According to an embodiment, referring to FIG. 3, a controller device 100 locally collects and aggregates all the data points from various sensors 200 and sub-systems within the building including, but not limited to, the following data points: fans, electric meters, elevators, occupancy counters, steam meters, internal or external air temperatures, water, and so on. To collect these data points, the controller device 100 can connect to an existing BMS 105 system over a variety of protocol (e.g., BACnet, Modbus, LonWorks, etc.). This controller device 100 is compatible with all the main BMS in the market (e.g., JCI, Schneider, Honeywell, Siemens, Automated Logic, Panasonic, Legrand, Delta, IBM, Hitachi). An exemplary cloud solution server 300 network is connected to and collects data from the controller device 100 by a data link 315 and one or more other data sources including weather stations 310. The cloud solution server 300 includes one or more databases that can store data received from the controller device 100 and the one or more other data sources. Data from edge building may be stored in a separate database. The controller device 100 is optionally configured to update information in the database at set intervals or when a change data is observed.

According to another embodiment, the cloud solution server 300 network collects data from multiple buildings, each one having their own controller device 100, 100, in communication with their respective electrical equipment, such as lighting, and with their respective HVAC controllers.

In some embodiments, as shown in FIG. 1B, the controller device 100 communicates with the HVAC controller or BMS/BAS 150 which, in turn, communicates with the components under its control. In an embodiment, the HVAC components 400 may be controlled by a HVAC controller which communicates directly with the controller device 100. In another embodiment, the HVAC controller, which communicates directly with the controller device 100, controls both the HVAC components 400 and the sensors 200, in order to obtain all the measured values from the sensors and send them to the controller device 100, and to communicate with the HVAC components after having received instructions from the controller device 100.

According to an embodiment, the data collected by device 100 from the variety of different sensors 200 located throughout the building is translated in a universal open format from the different protocols from which it is collecting the data, and sends the data to a database on a remote server 300, e.g., a cloud-computing database distributed on remote servers communicating in a network. This communication is preferably made over a wireless connection, and further preferably over an encrypted connection since private information can be collected by the sensors 200.

According to an embodiment, the database, preferably on a remote server 300 (e.g., on the cloud), aggregates all the data in an historic dataset and keeps a fine granularity of the historic time line for each data point. This database become overtime a big data picture of the thermodynamic behavior of the building and is used to extract additional value (e.g., trends) from the data set. Specific algorithms use the dataset to build a real time thermodynamic behavior models of the building including a prediction of the optimal settings of the different HVAC devices in real time.

A collection of control modules or algorithms can be executed by the controller device 100, in different combinations and orders, to leverage the thermodynamic model derived from the dataset with real time value of the data point, the number of persons in each zone and the outside weather parameters condition in real time and the forecast of the next few hours. Based on the results of execution of these control modules, one or more control commands may be generated and sent to the different controllers in the building, which can dictate the modulation of all the HVAC devices to maintain the desire temperature and humidity level in the building at all time. These commands may include optimal settings for the next time interval (example: 5 minutes), once the time interval has elapse, a new round of execution of control modules may be initiated by the controller device 100 to produce a new series of orders. This process may continue and self-adjust base on the behavior of the HVAC equipment.

According to an embodiment, the control modules may be distributed over the controller device 100 and the remote server 300 and 310. To optimize the response time in reason of network communication delays, some of the control modules may be executed on the controller device 100 and some may be executed in the cloud.

For example, control modules executed on device 100 may include those involving real time responses such as a sudden change of occupancy in a zone, and control modules executed on the remote server 300 involve those not related to real time responses, such as detecting trends and correlations between events and power demand, or applying weather forecasts to make power demand forecast. In other words, and in some embodiments, real time operations are preferably performed locally and analytics is preferably performed remotely. Privacy of data can also be taken into account when deciding if data is communicated over the internet to a remote server 300.

In one embodiment of the invention, control modules relating to dynamic thermal equilibrium process can be divided in different subgroups related to their functions, for example, control modules can be broadly divided into modules that specifically control air components of an HVAC, modules that specifically control water side components, modules that increase energy efficiency and/or reduce energy costs, and modules that optimize control of the HVAC system. For example, in some embodiments, subgroups of modules may specifically instruct particular HVAC components with respect to one or more of:
the air systems managing the ventilation, modulation of the air temperature and humidity of the air flowing in the building;
the cooling systems producing and distributing the cooling thermal load in the building, serving in most cases the different air systems;
the heating systems producing and distributing the heating thermal load in the building, serving in most cases the different air systems; and
the control systems.

Each of these subgroups has its own set of algorithms modeling the thermal flow of the building and calculating the optimal running configuration of the different HVAC device. The following is an example list of modules or algorithms per subgroup:

Regarding air systems, the controller device 100 can configure and execute control modules to perform the following operations (without limitation):
Modulate the fresh air intake based on the number of persons in each zone of the building.
Modulate the fresh air intake based on the outside temperate level.
Modulate the air flow speed based on the number of persons in each zone of the building.
Modulate the pressurization of each zone.
Modulate the humidity control required.
Modulate the duct static pressure based on the fan speed and the VAV modulation.
Modulate the supply air fans, hood exhaust and make-up fans based on an occupancy level of each zone.
Modulate the economy cycle (use outdoor air for space cooling) based on the exterior parameters and inside load.
Modulate the night purge based on weather parameter and forecast demand (flushing the building with cool outdoor air at night to avoid mechanical cooling at start-up).
Modulate the computer room air speed based on a cooling load (use air movement to remove heat load instead of supplying cold air to the room).
Modulate the humidification and de-humidification based on the load.

Regarding cooling systems, the controller device 100 can configure and execute control modules to performing the following operations (without limitation):
Modulate the staging of chillers and compressors based on the load balance along the optimal curve of the chillers.
Modulate the chilled water pumps speed base on the number of persons in the building.
Modulate the water evaporator pump of the water tower base on the number of persons in the building.
Modulate the chilled water temperature and speed flow base on the number of persons, outside temperature and wet bulb.
Modulate the condenser water delivery temperature to maintain the optimal coolest possible CW for cooling of refrigeration equipment.
Modulate the head pressure control (for air cooled condensers & water tower only) to maintain the optimal condenser fans energy consumption.
Modulate the condensing pressure based on the heat load to be extracted (for water-cooled condensers).
Modulate the staging of chillers and compressors based on the load balance along the optimal curve of the chillers.
Modulate the chilled water pumps speed base on the number of persons in the building.
Modulate the water evaporator pump of the water tower base on the number of persons in the building.
Modulate the chilled water temperature and speed flow base on the number of persons, outside temperature and wet bulb.
Modulate the condenser water delivery temperature to maintain the optimal coolest possible CW for cooling of refrigeration equipment.
Modulate the head pressure control (for air cooled condensers & water tower only) to maintain the optimal condenser fans energy consumption.
Modulate the condensing pressure based on the heat load to be extracted (for water-cooled condensers).

Regarding heating systems, the controller device 100 can configure and execute control modules to perform the following operations (without limitation):
Modulate the hot water/steam delivery temperature based on the heating demand load.
Modulate the boiler sequencing based on the load demand.
Modulate losses in de-energized boilers.
Modulate the steam pressure based on the load demand.

Regarding controls systems, the controller device 100 can configure and execute control modules to perform the following operations (without limitation):
Modulate space temperature set points and control bands based on the optimal range trend and deadband (albeit drifting).

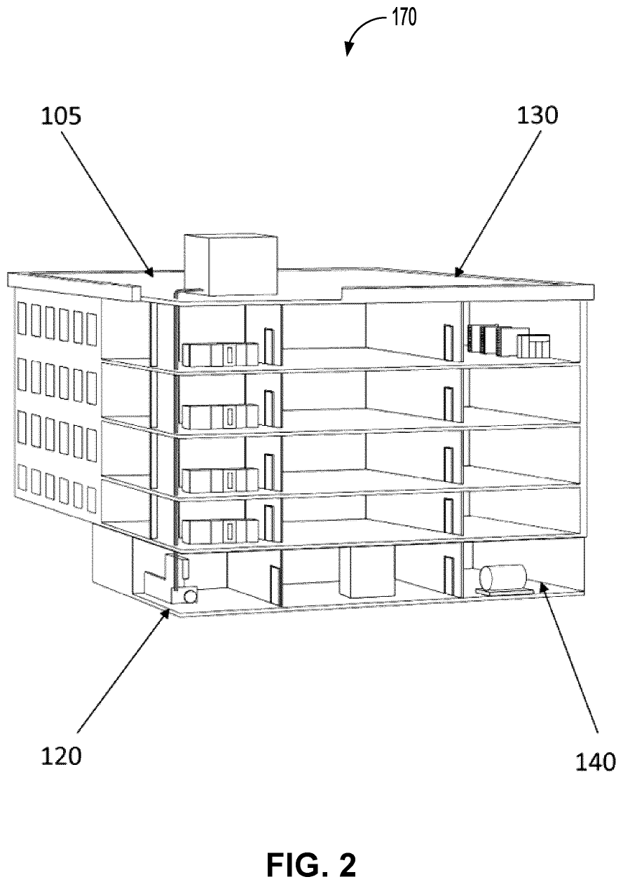

Referring now to FIG. 2, the controller device 100, by executing various control modules, can generate control commands to operate the following HVAC components 400 and parameters in the building 170, without requiring physical modification of the building 170:
A. Cooling production optimization 105
   Variable head pressure control (air cooled condensers & water tower).
   Adjust condensing pressure base on heat load to be extracted.
   Variable head pressure control (water-cooled condensers).
   Adjust head pressure of the condenser water base on heat load to be extracted.
   Optimized secondary chilled water pumping.
   Balance the quantity of chilled water circulated base on the AI-IU needs (reduce circulation when low request).
   Humidity control based on the outside humidity level.
   Predictive cooling production based on the weather forecast (6 hours).
   Balance the chiller temperature base on the evaporator target.
B. Distribution optimization 120
   Reset chilled water delivery temperature.
   Set the optimal warmest possible water for cooling.
   Reset ting condenser water delivery temperature.
   Set the optimal coolest possible CW for cooling of refrigeration equipment.
   Reset ting heating hot water de livery temperature.
   Set the optimal coolest possible water for heating.
   Heating water Delta T modulated with Pressure Delta P.
   Staging of chillers and compressors.
   Load balance the chillers at the optimal efficiency curve.
C. Ventilation and air flow optimization 130
   Supply air fans, hood exhaust and make-up fans.
   Reduce usage when not needed (occupancy driven).
   Use outdoor air for space cooling when possible.
   Night purge.
   Demand control ventilation base on controlling CO₂ for occupied
   space.
   Pre-emptive cooling or heating based on a sun position.
   Pre-emptive cooling or heating based on the number of persons in a zone.
   Demand control ventilation base on controlling CO levels.
   Duct static pressure rese.t
   Reduce fan speed in proportion of VAV modulation.
   Use air movement to remove heat load instead of supplying cold air to the room.
D. System control optimization 140
   Occupancy control.
   Automatic switching of ventilation system and lights if the presence of occupants in the area is detected.
   Optimum start/stop heating/cooling for each zone.
   Space temperature set points and control bands.
   Set the optimal range trend and deadband.
   Master air handling unit supply air temperature signal.
   Modulate master air feed temperature to avoid simultaneous heating and
   Cooling.

Examples of sensors 200 provided in a building 170 include, without limitation, temperature sensors (often in a thermostat), occupancy sensors, humidity sensors, pressure sensors, and sensors found within the HVAC system such as air speed sensors.

Other data not measured by the sensors 200 can be collected and used. For example, online calendars may be queried to detect upcoming events in particular locations in the building. In another example, the remote server 300 can query third party servers 600, as shown in FIGS. 1A and 1B, to collect weather forecasts for the location of the building, and take into account sunlight, temperature, wind, humidity, pressure and precipitation of the environment around the building to feed to the thermodynamic model of the building being computed by the remote server 300. For example, a given zone in the building may receive more sunlight than another and the remote server 300 may determine that an optimal course of action would be to trigger ventilation to have the air flow from one zone to another zone to warm the other zone without having to resort to the heating system and cool down the sunlit zone without needing the air conditioning system.

FIG. 4 is schematic diagram illustrating an exemplary architecture of a system including a controller device 100 for dynamic control of the HVAC components of a building, according to at least one embodiment. The system can simultaneously target multiple user objectives 110 based on client preferences. For example, the user objectives may include one or more of: (1) reducing operational costs, (2) reducing power consumption, (3) reducing electrical or gas consumption, (4) reducing or meeting GHG Emission targets, (5) reducing equipment runtime or cycling rates, (6) maintaining or improving space temperature or indoor air quality, (7) meeting space humidity requirements, and so on. The user objectives 110 can each be assigned weights based on how important they are to the client. These weights can be adjusted dynamically during operation in response to changing client preferences, and the BMS adapts its operation accordingly. A set of weighted objectives can be referred to “user objectives” or “desired outcomes”.

The system may include a database server 450 connected to the controller device 100. The database server 450 is connected to a dashboard display device 420 and a monitoring system 460. The controller device 100 may implement relational-control algorithms to monitor, via the monitoring system 460, different parameters of the entire fleet of HVAC components 400 and sensors 200 within a building 170 to deliver continuous, automatic adjustments to the system based on the building load, regardless of facility type. The goal of these systems and methods is to generate energy usage savings (kWh/yr.), demand savings (KW), heating/cooling load (T herms), cooling tower water usage savings (gal/yr.), carbon footprint reduction (lbs./yr.) and Power Usage Effectiveness (PUE) Reduction. By doing so, these systems and methods save impressive amount of dollars, reduce the load on the grid and improve tenant comfort.

The system may maintain a library of different control modules 480 on the database server 450 for HVAC equipment, each of which can be dynamically enabled or disabled as needed, and configured to operate in concert with other enabled algorithms or algorithms. The system can accommodate control modules of varying complexity, ranging from simple control loops, to complex mathematical functions, to deep learning techniques. Various types of control modules are supported, e.g., equipment-specific modules (chiller, boiler, air handler, etc.), application-specific modules (controlling start/stop), modulation algorithms, and so on. Each control module 480 can be viewed as a building block, which can be assembled in various combinations. Each combination can be viewed as a “path to a desired outcome.” Example control modules 480 may include one or more of: temperature prediction, control sequence input generation, multiple competing control sequence input management, power control, equipment tracking and fault detection, trajectory simulation and comparison, building safety verification and validation, and multi-agent building community behavior management.

The control device 100 is configured to simulate performance of the BMS system 150 (e.g., temperature/humidity of particular spaces, demand levels, emissions, etc.) during multiple rounds of execution of one or more control modules. During each round, a different combination and order of the control modules may be executed. In this way, each “path to a desired outcome” can be evaluated, and an optimal path that brings the BMS closest to the client's desired outcome can be selected. The simulations may be analyzed and compared by the control device 100, which may implement a powerful prediction engine that ingests inputs (e.g., weather forecasts—e.g., next few hours), occupancy rates, emissions dates, etc., to predict the performance of particular paths.

The system be configured to provide a modular and integrated approach to deploy the control modules 480. Each control module 480 can be removed and installed at ease, in real time, for dynamic management of one or more HVAC components 400. The modular approach enables the system to provide a customized control for each BMS 150 and building 170.

An example energy saving control module may be configured to save as much energy as possible by managing optimal start and stop times for the HVAC components 400 within a HVAC system. The energy saving control module may use temperature predictions, which may be generated by a separate temperate prediction module, as well as a current outdoor air temperature condition and building conditions, which may be sent from a BMS 150, to decide when the optimal time is to start and stop one or more HVAC components 400.

Another example control module may be configured to modulate chiller or boiler delivery temperature in accordance with the a predicted outdoor air temperature, a predicted building thermal load, which may be generated by a separate thermal load prediction module, and a present outdoor air temperature, which may be sent from a third party weather database or a sensor 200. This control module may be configured to determine one or more setpoints for chillers, boilers or variable-speed fan cooling towers.

In addition, a non-exhaustive list of example control modules may include:
Time Module keeps track of temporal aspects of the building and the system general
Building Module contains description of the building, including equipment, points, hierarchy of systems
Data Module contains functions to fetch and pre-process building data from one or more databases
Safety Module configures building-agnostic rules to prevent non-safe operation of building components.
Guardian Module configures building-aware rules to prevent non-safe operation of building components; leveraging building hierarchy and user-settings from the Building Module
Health Module performs data-driven fault detection approach adapted to prevent non-safe operation of building components
Prediction Module contains predictive models non-limited to space temperature
Power Module sets virtual metering of equipment to estimate energy draw of equipment given input action either factual or proposed, executes methods to link equipment energy draw with grid cleanliness index and GHG CO₂-eq, and executes methods to link equipment energy draw with utility billing rates and costs
Control Module contains and executes methods to process control programs, algorithms and logic, where control programs can be written in non-PLC languages such as Python, and forwards commands to the BMS 150 or directly to HVAC components 400.
Multi-Control Module contains and executes methods to compare, rank, select and blend multiple streams of control signals based on user-input or external signals or weights.
Occupancy Module contains and executes methods to estimate likelihood of presence, earliest arrival, latest departure, length of presence, period of non-presence signaling full-day absence, and density estimation
Comfort Module estimates level of comfort in space; can be linked to user feedback and can include other non-temperature factors like glare, acoustics, and so on
Equipment Module estimates the cycling rate of equipment and length of ON and OFF times.

In some embodiments, the controller device 100 may determine a particular combination of control modules based one or more of the follow factors:
Type of HVAC equipment in the building (e.g., chiller, boiler, air handling unit or AHU)
Operating parameters of the building (e.g., scheduled occupancy or 24/7 facilities).
Tariff structure
CO2 emissions caps, commitments or regulations.

The controller device 100 may be configured and installed to connect with HVAC components 400 directly, and when the controller device 100 is deployed at an existing building, the controller device 100 can connect with an existing control system, such as BMS 150, with existing control loops for HVAC components 400. In the latter situation, the existing control loops are included within the above-noted simulations. When use of an existing control loop is predicted to be part of the optimal path, then the controller device 100 may yield control of HVAC components 400 to the existing control loop of the BMS 150. In some examples, control is yielded until it is no longer optimal. In other examples, the controller device 100 may take over control of the HVAC components 400, in which case, the previous control loop of the BMS 150 may be completely overwritten or overridden.

The controller device 100 enables a client to create its own custom logic. Clients can have multiple versions of BMS systems in their buildings, each with their own software, firmware or control loop. Making any changes to existing sequences of operation can be laborious, expensive and vendor dependent. The controller device 100 provides clients with a standard programming and vendor agnostic platform to write its own proprietary logic and push it down to the underlying building BMS 150.

The system may include a display device 420 such as a dashboard, which may be configured to display a plurality of data items such as user objectives, control module combinations being deployed for each BMS 150, and other metrics. In some embodiments, as the controller device 100 has completed one or more simulations based on the one or more control modules 480, the controller device 100 may render a user interface at the display device 420 with one or more different achievable outcomes, to prompt the user to review and if appropriate, re-evaluate preferences or objectives. For example, the controller device 100 may tell a user that a certain amount of savings can be achieved if the weight assigned to the comfort objective is reduced by a certain percentage or amount. The display device 420 may offer users and clients to interface with their buildings/assets at a higher-level interface.

In some embodiments, the controller device 100 can be configured to provide:
Native cloud control module management
User defined module or algorithm support (e.g., Python)
Building Algorithm Manager (algorithm view, start/stop)
Comparison of different algorithms or modules by outcome
Equipment Cost Calculator ($, kWh, kW, CO2)
Automated Emissions Reduction algorithms enable control by CO2 budgets or minimization
Equipment runtime and cycle count calculator and optimizer.
Advanced occupant comfort optimizer (temperature, RH, clothing, or metabolic rate).

By leveraging the accuracy of various prediction models, the controller device 100 calculates a sequence of possible trajectories, and returns the optimal combination with respect to specific user objectives. In some embodiments, the control device 100 can leverage machine learning models to drive controls directly, e.g., by using reinforcement learning agents.

The controller device 100 can compare the performance gains of the control modules 480 over traditional reactive controls. The controller device 100 can combine solutions from any optimization algorithm, allowing future performance improvements without any deployment structure obsolescence.

In some embodiments, one or more control modules 480 may utilize artificial intelligence (AI) for:
Training of building specific AI model(s)
Comparison of model performance
Model parameter management.

The foregoing aspects provide a controller device 100 that can reconfigure itself dynamically, for example, by selecting a different combination of control modules 480 in response to both (i) changing client objectives, and (ii) changing conditions such as, for example, weather, occupancy, and so on.

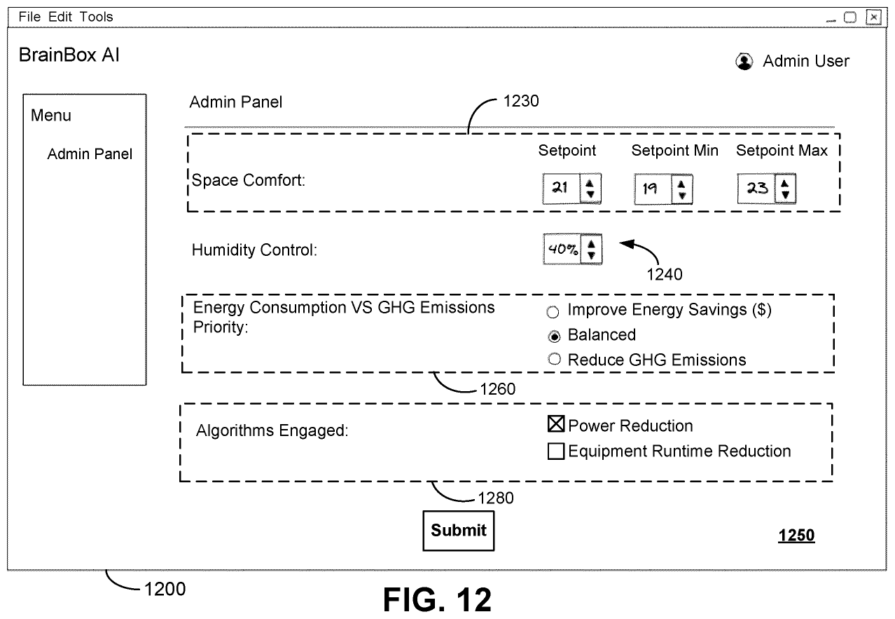

FIG. 12 illustrates an example user interface (UI) 1200 for dynamic management of the HVAC components of a building, according to one embodiment. The UI 1200 may be rendered by a controller device 100 for display at a display device 420. The UI 1200 may include graphical user interface (GUI) elements configured to receive one or more user input representing one or more user objectives 110, which may be input to the controller device 100 for dynamic management of the HVAC components.

In some embodiments, a user, such as an administrator of a HVAC building, may log into the system and be presented with the UI 1200. The UI 1200 may include an admin panel 1250, which may include, for example, a side menu bar, a first area 1230 for receiving a user objective indicating space comfort, a second area 1240 for receiving a user objective indicating a humidity control, a third area 1260 for receiving a user objective indicating a selected option regarding energy consumption, and a fourth area 1280 for receiving a user objective indicating a selected option regarding one or more engaged control modules or algorithms.

The user objectives 100 that may be received by the control module 110 via the UI 1200 may include, for example: (1) reducing operational costs, (2) reducing power consumption, (3) reducing electrical or gas consumption, (4) reducing or meeting GHG Emission targets, (5) reducing equipment runtime or cycling rates, (6) maintaining or improving space temperature or indoor air quality, (7) meeting space humidity requirements.

The first area 1230 for receiving a user objective indicating space comfort may include a setpoint value, which may be units in Celsius or Fahrenheit. In the UI 1200 shown in FIG. 12, it is in Celsius. The setpoint value indicates a desired temperature. There may be additional user input for the setpoint, including a minimum setpoint and a maximum setpoint. The minimum setpoint and the maximum setpoint values may be determined based on user input, or may be in some embodiments determined based on the setpoint value indicating the desired temperature. For instance, if the user enters 21 (Celsius) in the setpoint field, the minimum setpoint field may be automatically set to setpoint minus 2 and the maximum setpoint field may be automatically set to setpoint plus 2.

The second area 1240 for receiving a user objective indicating a humidity control may include a user input field, which may receive value indicating a humidity level, e.g., 40%.

The third area 1260 for receiving a user objective indicating a selected option regarding energy consumption VS GHG Emissions Priority may include a plurality of possible options, including for example: 1) improve energy savings, 2) reduce GHG emissions, and 3) a balanced approach between option 1) and 2). There may be a default option, e.g., the balanced approach, if the user has not yet clicked on or set any initial energy consumption preferences.

The fourth area 1280 for receiving a user objective indicating a selected option regarding one or more engaged control modules or algorithms may include a plurality of control modules 480 or algorithms available for engagement or deployment. For example, the third area 1280 may show a power reduction module and an equipment runtime reduction module. Other control modules may be shown and for user to select for engagement or deployment.

In some embodiments, as the controller device 100 detects that one or more user objectives 100 has been added, removed, or changed, the controller device 100 may configure and execute one or more control modules 480 to generate a new set of simulations based on the changed user objectives, and in turn, determine an updated set of control modules 480 based on for the most recent user objectives, one or more forecasts, and the current conditions of the building 170. For example, assume a building owner (i.e., a client) initially wants to maintain the space temperature at 21 Celsius degrees and the tariff structure of the electricity bill is initially flat (e.g. $0.15/kWh 24/7/365). The controller device 100 may initially deploy certain control modules depending on the HVAC equipment and operating parameters of the building 170 in order to reach the “desired outcome” of minimizing energy (kWh) which minimizes cost ($), through for example, execution of AI-based control module to start, stop, or reset boiler, chiller or any other HVAC component 400. The electric utility then changes the tariff structure to one that has a time dependent rate (e.g. $0.20/kWh from 12 PM-3 PM and $0.12/kWh the rest of the day). The controller device 100 can now pre-cool the building down to 19 Celsius degrees (a new owner approved low limit) using the cheaper rate of 12 cents and then turn off the cooling and let the building “drift” up to 23 deg C. (a new owner approved high limit) during the more expensive 12-3 PM slot.

It is common for buildings to be designed with oversized HVAC equipment and to be programmed to overcool or overheat when a high temperature or low temperature event occurs. In some embodiments, as the controller device 100 detects can deploy control modules depending on the HVAC equipment and operating parameters of the building to minimize energy consumption and cost while maintaining/improving comfort (adherence to a setpoint, e.g., 21 Celsius degrees). This can be achieved by predicting, via a prediction control module, when the HVAC system needs to start heating or chilling in the morning based on today's weather forecast (e.g. start at 6:30 AM for a 7:00 AM occupancy start vs. the statically programmed HVAC schedule of 6 AM). However, if the predicted weather is too high or low then an AI-based control module will release the building back to the BMS 150 so it can turn on as early as possible to meet the anticipated demand for cooling or heating.

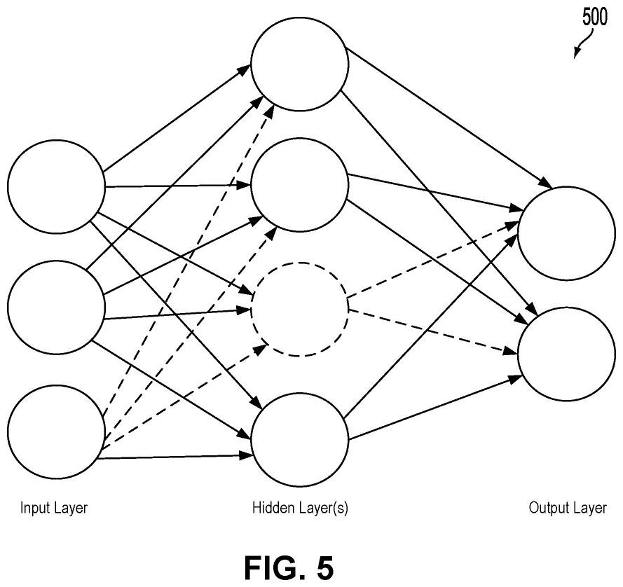

As mentioned, one or more control modules 480 may be implemented based on machine learning and neural network models. Depicted in FIG. 5, a neural network may have an architecture 500 including an input layer, a plurality of hidden layers, and an output layer. The input layer receives input features. The hidden layers map the input layer to the output layer. The output layer provides the prediction of the neural network. In other embodiments, other suitable deep learning models and architectures can be used.

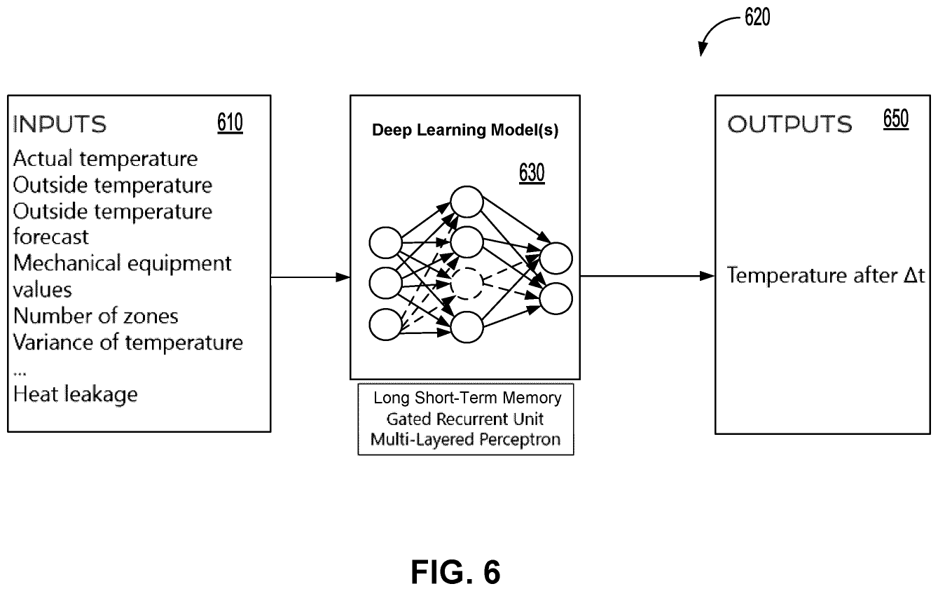

FIG. 6 illustrates an example block diagram 620 including an example set of inputs 610, an example set of outputs 630 and one or more machine learning based control modules 630 maintained by a controller device 100 for dynamic management of the HVAC components of a building, according to one embodiment. The inputs 610 to the machine learning based control modules 630 may include one or more of: actual temperature, outside temperature, outside temperature forecast, mechanical equipment values, number of zones, variance of temperature, and heat leakage. The output 650 from the machine learning based control modules 630 may be a temperature after a certain period of time, Δt.

One or more input 610 may be obtained or received from the BMS 150 or sensors 200 of the building, including for example, actual temperature, mechanical equipment values, number of zones, and heat leakage. One or more input 610 may be forecasted values obtained from a third party, such as outside temperature forecast. One or more input 610, such as variance of temperature, may be forecasted value(s) from one or more control modules configured to predict such values.

The one or more machine learning based control modules 630 may be implemented based on one or more machine learning models such as, for example, long short-term memory, gated recurrent unit, or multi-layered perception.

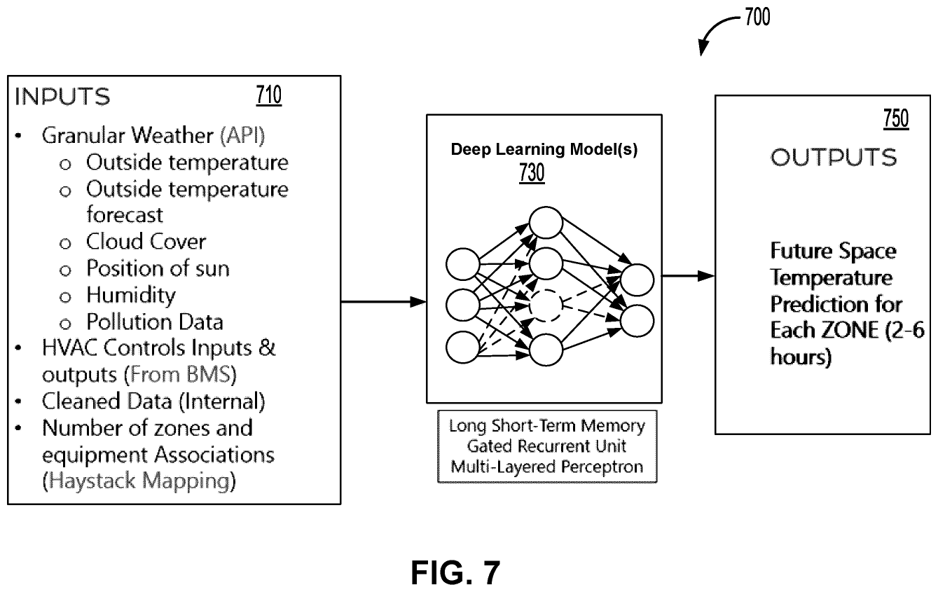

FIG. 7 illustrates an example block diagram 700 showing an example set of inputs 710 and outputs 750 for one or more machine learning based control modules 730 maintained by a controller device 100 for dynamic management of the HVAC components of a building, according to one embodiment. The input 710 to the machine learning based control modules 730 may include one or more of: outside temperature, outside temperature forecast, cloud cover, position of sun, humidity, pollution data, HVAC controls inputs and outputs (from BMS 150), internal cleaned data, a number of zones and equipment associations. The output 750 from the machine learning based control modules 730 may be a predicted space temperature prediction for each zone (e.g., 2-6 hours).

One or more input 710 may be obtained or received from the BMS 150 or sensors 200 of the building, including for example, outside temperature, cloud cover, position of sun, humidity, pollution data, a number of zones and equipment associations. One or more input 710 may be forecasted values obtained from a third party, such as outside temperature forecast.

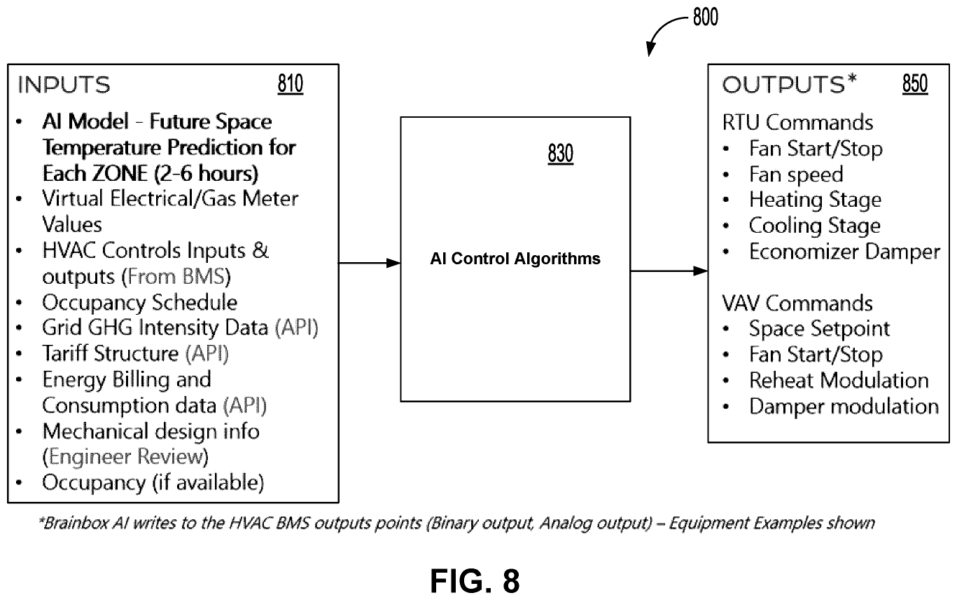

FIG. 8 illustrates an example block diagram 800 showing an example set of inputs 810 and outputs 850 for one or more control modules 830 maintained by a controller device 100 for dynamic management of the HVAC components of a building, according to one embodiment. The input 810 to the machine learning based control modules 830 may include one or more of: predicted space temperature prediction for each zone from the control module 100, virtual electrical or gas meter values, HVAC controls inputs and outputs (from BMS 150), occupancy schedule (from BMS 150 or a third party database), grid GHG intensity data (from an API or third party database), tariff structure (from an API or third party database), energy billing and consumption data (from an API or third party database), mechanical design information (from BMS 150 or engineer review), and occupancy (from BMS 150 or sensors 200). The output 850 from the one or more control modules 830 may include: roof-top unit (RTU) and/or Variable Air Volume (VAV) commands. RTU commands may include, for example: fan start/stop, fan speed, heating stage, cooling stage, and economizer damper. VAV commands may include, for example: space setpoint, fan start/stop, reheat modulation and damper modulation.

In some embodiments, the controller device 100 can send the commands directly to the HVAC BMS outputs points (e.g., binary output, analog output) to dynamically control and manage the HVAC components 400.

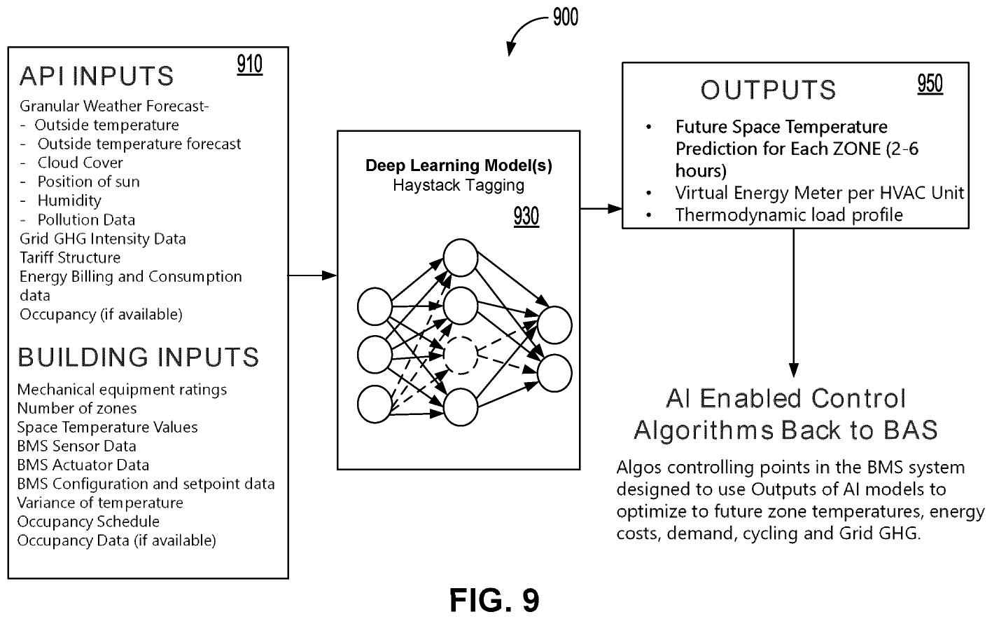

FIG. 9 illustrates an example block diagram 900 showing another example set of inputs 910 and outputs 950 for one or more deep learning control modules 930 maintained by a controller device 100 for dynamic management of the HVAC components 400 of a building 170, according to one embodiment. The input 910 to the machine learning based control modules 930 may include one or more of:
Granular Weather Forecasts including:
   current outside temperature
   outside temperature forecast
   cloud cover
   position of sun
   humidity
   pollution data
Grid GHG Intensity Data
Tariff Structure
Energy Billing and Consumption data
Occupancy data
Inputs related to the building from BMS 150 including:
   mechanical equipment ratings
   number of zones
   space temperature values
   BMS sensor data
   BMS actuator data
   BMS configuration and setpoint data
   variance of temperature
   occupancy schedule
   occupancy data

The output 950 from the machine learning based control modules 930 may include one or more of:
Future Space Temperature Prediction for each zone (e.g., 2-6 hours)
Virtual Energy Meter per HVAC Unit
Thermodynamic load profile

The machine learning based control modules 630, 730, 830, 930 are examples of control modules 480 maintained by the controller device 100. In some embodiments, one or more output from the machine learning based control modules 630, 730, 830, 930 can be sent to the BMS 150 to control and optimize future zone temperatures, energy costs, demand, cycling and Grid GHG.

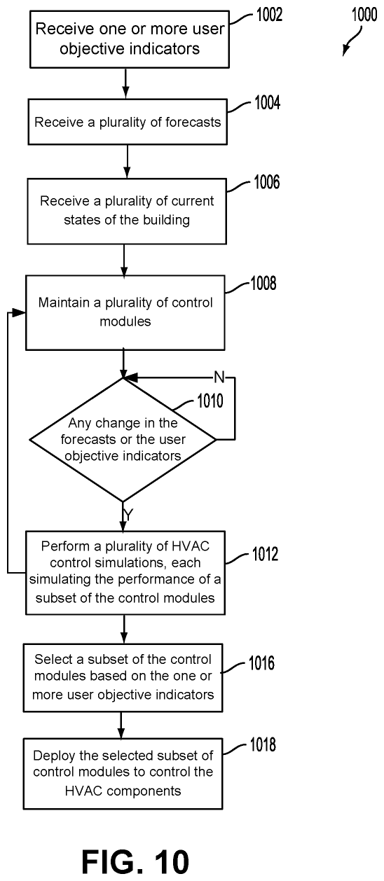

FIG. 10 is an example process 1000 performed by a controller device 100 for dynamic management of the HVAC components 400 of a building 170, according to one embodiment.

At step 1002, the controller device 100 receives one or more user objective indicators, each indicating a corresponding user objective for the HVAC components 400. In some embodiments, the one or more user objective indicators may include at least one of: an operational cost, a power, a water usage amount, an electricity usage amount, a gas usage amount, a humidity level, an emission target, equipment runtime, an equipment cycling rate, a temperature target, and an air quality target.

At step 1004, the controller device 100 receives a plurality of forecasts, each predicting a dynamic state of the building or a usage parameter of one of the HVAC components 400.

In some embodiments, the plurality of forecasts may include at least one of: a predicted temperature value, a predicted water usage amount, a predicted electricity usage amount, a predicted gas usage amount, a predicted weather, and a predicted humidity level.

At step 1006, the controller device 100 receives a plurality of current states of the building. In some embodiments, the plurality of current states of the building may include at least one of: a number of zones, a temperature measurement, a set point, sensor data, actuator data, occupancy schedule, and occupancy data.

In some embodiments, the plurality of current states of the building is received from a Building Management System (BMS).

At step 1008, the controller device 100 maintains a plurality of control modules, each for controlling at least one setting of the HVAC components. In some embodiments, at least one of the plurality of control modules may include a machine learning model.

At step 1010, the controller device 100 checks to see if there is any change in at least one of the forecasts or at least one of the user objective indicators. If there is a change in at least one of the forecasts or at least one of the user objective indicators, upon detecting the change at step 1012, the controller device 100 performs a plurality of HVAC control simulations, each simulating the performance of a corresponding subset of the control modules based on the plurality of forecasts and the plurality of current states of the building.

At step 1012, as an optional step, prediction values generated in the course of control simulations can act as feedback to the controller device 100 at step 1008, which maintains a plurality of control modules.

At step 1016, the controller device 100 selects a subset of the control modules from among the simulated subsets of the control modules based on results of the simulations and the one or more user objective indicators.

At step 1018, the controller device 100 deploys the selected subset of control modules to control the HVAC components 400.

In some embodiments, deploying the selected subset of control modules to control the HVAC components may include: executing the selected subset of control modules; and generating one or more operating values for the HVAC components based on the execution of the selected subset of control modules; and transmitting the one or more operating values to the HVAC components.

In some embodiments, one or more output from the selected subset of control modules may be used to dynamically calibrate the control modules (e.g., by adjusting weights of certain parameters in a machine learning model) implemented by the controller device 100.

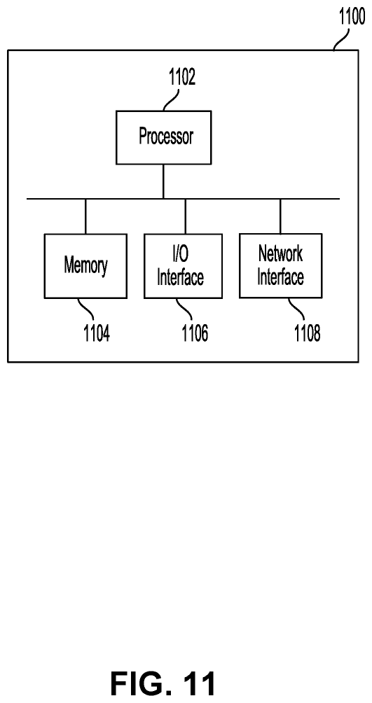

FIG. 11 is a schematic diagram of computing device 1100 which may be used to implement the controller device 100, in accordance with an embodiment.

As depicted, computing device 1100 includes at least one processor 1102, memory 1104, at least one I/O interface 1106, and at least one network interface 1108.

Each processor 1102 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1104 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1106 enables computing device 1100 to interconnect with one or more input devices, such as a keyboard, mouse, camera, touch screen and a microphone, or with one or more output devices such as a display screen and a speaker.

Each network interface 1108 enables computing device 1100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 1100 is shown but system 100 may include multiple computing devices 1100. The computing devices 1100 may be the same or different types of devices. The computing devices 1100 may be connected in various ways including directly coupled, indirectly coupled via a network, and distributed over a wide geographic area and connected via a network (which may be referred to as “cloud computing”).

For example, and without limitation, a computing device 1100 may be a server, network appliance, set-top box, embedded device, computer expansion module, personal computer, laptop, personal data assistant, cellular telephone, smartphone device, UMPC tablets, video display terminal, gaming console, or any other computing device capable of being configured to carry out the methods described herein.

In some embodiments, a computing device 1100 may be adapted to function as a controller device 100.

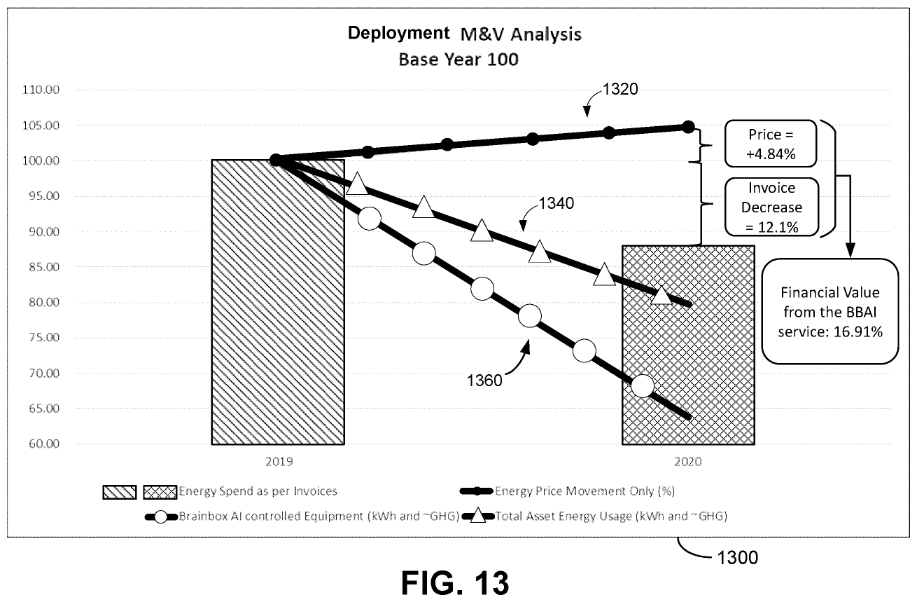

FIG. 13 illustrates an example graph 1300 showing energy savings after deployment of an example system for dynamic management of the HVAC components of a building, according to one embodiment. A first plotted data line 1320 represents energy price movement in terms of percentage (%). A second plotted data line 1340 represents a total asset energy usage (kWh and GHG). A third plotted data line 1360 indicates energy usage (kWh and GHG) by the example system (e.g., Brainbox AI controlled equipment).

During a live deployment of an example embodiment of the system disclosed herein, over a period of approximately three months, the system has been detected to achieve an energy savings relating to the HVAC components to a total asset amount of 36.45% or 49,604 kWhs. In addition, there has been a reported increase in comfort of greater than 54%, as measured by the reduced variance from a desired setpoint. There has been a reduction of cost to the amount of 16.91%, and a reduction of greenhouse gas (GHG) emissions to the amount of 20.25%.

Total asset kilowatt hours may include lighting, vertical transport and other power. Total asset includes network charges that are billed on a kVA basis.

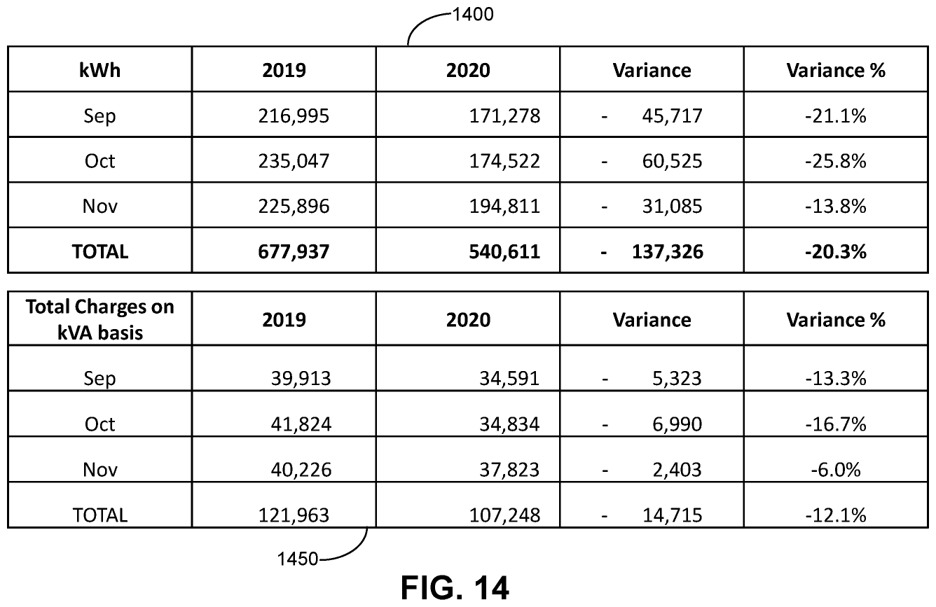

FIG. 14 illustrates two tables 1400, 1450 showing energy savings after deployment of an example system for dynamic management of the HVAC components of a building, according to one embodiment. Under the International Performance Measurement and Verification Protocol (IPMVP®) protocol, weather has been normalized where appropriate.

Over the course of 89 days, energy measurement data as per the IPMVP protocol has been gathered, and a saving of 49,604 kilowatt hours is reported. The 49,604 kWh represents a percentage reduction of 36.45%.

In addition, average runtime for a number of different HVAC system components have been reduced when the HVAC building is connected to and managed by the example embodiment system. For instance, table below shows an average runtime reduction for each of a mall heat pump fan, a library heat pump fan, a shop heat pump fan, and condenser pumps.

| SYSTEM | AVERAGE RUNTIME REDUCTION (%) |
|---|---|
| Mall Heat Pump Fan | 41% |
| Library Heat Pump Fan | 35% |
| Shop Heat Pump Fan | 42% |
| Condenser pumps | 60% |

The discussion herein provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the discussion herein, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which may be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

1. A computer-implemented system for controlling HVAC components of a building, the system comprising:
a processor;
a memory storage device storing a set of instructions, the set of instructions when executed by the processor, cause the processor to:
receive one or more user objective indicators, each indicating a corresponding user objective for the HVAC components;
receive a plurality of forecasts, each predicting a dynamic state of the building or a usage parameter of one of the HVAC components;
receive a plurality of current states of the building;
maintain a plurality of control modules, each for controlling at least one setting of the HVAC components; and
upon detecting a change in at least one of the forecasts or at least one of the user objective indicators:
perform a plurality of HVAC control simulations, each simulating the performance of a corresponding subset of the control modules based on the plurality of forecasts and the plurality of current states of the building;
select a subset of the control modules from among the simulated subsets of the control modules based on results of the simulations and the one or more user objective indicators; and
deploy the selected subset of control modules to control the HVAC components.

2. The system of claim 1, wherein the plurality of forecasts comprise at least one of: a predicted temperature value, a predicted water usage amount, a predicted electricity usage amount, a predicted gas usage amount, a predicted weather, and a predicted humidity level.

3. The system of claim 1, wherein at least one of the plurality of control modules comprises a machine learning model.

4. The system of claim 1, wherein the plurality of current states of the building comprise at least one of: a number of zones, a temperature measurement, a set point, sensor data, actuator data, occupancy schedule, and occupancy data.

5. The system of claim 4, wherein the plurality of current states of the building is received from a Building Management System (BMS).

6. The system of claim 1, wherein the one or more user objective indicators comprises at least one of: an operational cost, a power, a water usage amount, an electricity usage amount, a gas usage amount, a humidity level, an emission target, equipment runtime, an equipment cycling rate, a temperature target, and an air quality target.

7. The system of claim 1, wherein deploying the selected subset of control modules to control the HVAC components comprises:
executing the selected subset of control modules; and
generating one or more operating values for the HVAC components based on the execution of the selected subset of control modules; and
transmitting the one or more operating values to the HVAC components.

8. The system of claim 7, wherein the system further comprises a display device for displaying the one or more operating values for the HVAC components.

9. The system of claim 1, wherein the user objective indicators are weighted.

10. A computer-implemented method for controlling HVAC components of a building, the method comprising:
receiving one or more user objective indicators, each indicating a corresponding user objective for the HVAC components;
receiving a plurality of forecasts, each predicting a dynamic state of the building or a usage parameter of one of the HVAC components;
receiving a plurality of current states of the building;
maintaining a plurality of control modules, each for controlling at least one setting of the HVAC components; and
upon detecting a change in at least one of the forecasts or at least one of the user objective indicators:
performing a plurality of HVAC control simulations, each simulating the performance of a corresponding subset of the control modules based on the plurality of forecasts and the plurality of current states of the building;
selecting a subset of the control modules from among the simulated subsets of the control modules based on results of the simulations and the one or more user objective indicators; and
deploying the selected subset of control modules to control the HVAC components.

11. The method of claim 10, wherein the plurality of forecasts comprise at least one of: a predicted temperature value, a predicted water usage amount, a predicted electricity usage amount, a predicted gas usage amount, a predicted weather, and a predicted humidity level.

12. The method of claim 10, wherein at least one of the plurality of control modules comprises a machine learning model.

13. The method of claim 10, wherein the plurality of current states of the building comprise at least one of: a number of zones, a temperature measurement, a set point, sensor data, actuator data, occupancy schedule, and occupancy data.

14. The method of claim 13, wherein the plurality of current states of the building is received from a Building Management System (BMS).

15. The method of claim 10, wherein the one or more user objective indicators comprises at least one of: an operational cost, a power, a water usage amount, an electricity usage amount, a gas usage amount, a humidity level, an emission target, equipment runtime, an equipment cycling rate, a temperature target, and an air quality target.

16. The method of claim 10, wherein deploying the selected subset of control modules to control the HVAC components comprises:
executing the selected subset of control modules; and
generating one or more operating values for the HVAC components based on the execution of the selected subset of control modules; and
transmitting the one or more operating values to the HVAC components.

17. The method of claim 10, wherein the user objective indicators are weighted.

18. A computer-implemented system for controlling HVAC components of a building, the system comprising:
a building management system (BMS) configured to manage and maintain a plurality of current states of the building;
a computing device connected to the BMS and having a processor and a memory storage, the memory storage storing a set of instructions, when executed by the processor, causing the processor to:
receive one or more user objective indicators, each indicating a corresponding user objective for the HVAC components;
receive a plurality of forecasts, each predicting a dynamic state of the building or a usage parameter of one of the HVAC components;
receive the plurality of current states of the building from the BMS;
maintain a plurality of control modules, each for controlling at least one setting of the HVAC components; and
upon detecting a change in at least one of the forecasts or at least one of the user objective indicators:
perform a plurality of HVAC control simulations, each simulating the performance of a corresponding subset of the control modules based on the plurality of forecasts and the plurality of current states of the building;
select a subset of the control modules from among the simulated subsets of the control modules based on results of the simulations and the one or more user objective indicators; and
deploy the selected subset of control modules to control the HVAC components.

19. The system of claim 18, wherein the plurality of forecasts comprise at least one of: a predicted temperature value, a predicted water usage amount, a predicted electricity usage amount, a predicted gas usage amount, a predicted weather, and a predicted humidity level.

20. The system of claim 18, wherein at least one of the plurality of control modules comprises a machine learning model.

21. The system of claim 18, wherein the plurality of current states of the building comprise at least one of: a number of zones, a temperature measurement, a set point, sensor data, actuator data, occupancy schedule, and occupancy data.

22. The system of claim 18, wherein the one or more user objective indicators comprises at least one of: an operational cost, a power, a water usage amount, an electricity usage amount, a gas usage amount, a humidity level, an emission target, equipment runtime, an equipment cycling rate, a temperature target, and an air quality target.

23. The system of claim 18, wherein the user objective indicators are weighted.

24. A non-transitory computer-readable medium having stored thereon machine interpretable instructions which, when executed by a processor, cause the processor to perform the computer-implemented method claimed in claim 10.
